(19) United States
(12) Patent Application Publication
(10) Pub. No.: US 2024/0018333 A1
(43) Pub. Date: Jan. 18, 2024

(54) Producing Recycled Carbon Black from Waste Tires

(71) Applicant: ExxonMobil Technology and Engineering Company, Baytown, TX (US)

(72) Inventors: Shuhui Kang, Houston, TX (US); Alexander V. Zabula, Seabrook, TX (US); Brian J. Rohde, Houston, TX (US); Sergey Yakovlev, Baytown, TX (US); Chaky D. Muankaew, League City, TX (US); Jianya Cheng, Kingwood, TX (US)

(21) Appl. No.: 18/350,824

(22) Filed: Jul. 12, 2023

Related U.S. Application Data
(60) Provisional application No. 63/390,083, filed on Jul. 18, 2022.

(51) Int. Cl. C08J 11/20; C09C 1/48; G01N 30/86; C10G 1/10

(52) U.S. Cl. CPC C08J 11/20; C09C 1/487; G01N 30/8624; C10G 1/10; C08J 2321/00; C08J 2307/00; C10G 2300/1003

(57) ABSTRACT

A variety of methods/systems/apparatus/compositions are disclosed, including, in one embodiment, a method including introducing a polymeric material, an unsaturated compound, and an olefin cross metathesis catalyst into a reactor, wherein the polymeric material comprises a carbon black filler; reacting at least a portion of the polymeric material with the unsaturated compound in the presence of the olefin cross metathesis catalyst to produce at least metathesis oil and metathesis carbon black, wherein the metathesis oil comprises an olefin cross metathesis product of the polymeric material and the unsaturated compound; and separating at least a portion of the metathesis carbon black.

### CROSS REFERENCE TO RELATED APPLICATIONS

This application claims the benefit of and priority to U.S. Provisional Application No. 63/390,083 filed Jul. 18, 2022, the disclosure of which is incorporated herein by reference.

### FIELD

This application relates to methods for chemically recycling tires produce recycled tire materials including reclaimed carbon black.

### BACKGROUND

Tire pyrolysis is often utilized to recover materials from scrap tires. Tire pyrolysis involves heating tires at harsh process conditions, typically greater than 400° C., to chemically break down the tires. The tire pyrolysis process has low selectivity to high value products. The most valuable product of tire pyrolysis is low-quality pyrolytic carbon black (pCB) which can be used as a reinforcing filler in tire production only in the form of blends with virgin carbon black. Another major product of tire pyrolysis is pyrolysis oil (pOil) which is typically used for energy recovery such as blending with diesel fuels.

### SUMMARY

Disclosed herein is an example method including introducing a polymeric material, an unsaturated compound, and an olefin cross metathesis catalyst into a reactor, wherein the polymeric material comprises a carbon black filler; reacting at least a portion of the polymeric material with the unsaturated compound in the presence of the olefin cross metathesis catalyst to produce at least metathesis oil and metathesis carbon black, wherein the metathesis oil comprises an olefin cross metathesis product of the polymeric material and the unsaturated compound; and separating at least a portion of the metathesis carbon black.

Further disclosed herein is an example method including introducing a polymeric material, an unsaturated compound, and an olefin cross metathesis catalyst into a screw extruder, wherein the polymeric material comprises a carbon black filler; mixing the polymeric material and the unsaturated compound in a mixing zone in the screw extruder; reacting at least a portion of the polymeric material with the unsaturated compound in the presence of the olefin cross metathesis catalyst to produce at least metathesis oil and metathesis carbon black, wherein the metathesis oil comprises an olefin cross metathesis product of the polymeric material and the unsaturated compound; and separating at least a portion of the metathesis carbon black.

Further disclosed herein is an example method including introducing a polymeric material, a gaseous unsaturated compound, and an olefin cross metathesis catalyst into a reactor, wherein the polymeric material comprises a carbon black filler; reacting at least a portion of the polymeric material with the gaseous unsaturated compound in the presence of the olefin cross metathesis catalyst at a temperature of about 10° C. to about 100° C. to produce at least metathesis oil and metathesis carbon black, wherein the metathesis oil comprises an olefin cross metathesis product of the polymeric material and the gaseous unsaturated compound; and separating at least a portion of the metathesis carbon black.

Further disclosed herein is a metathesis oil composition comprising an olefin cross metathesis product of a polymeric material and an unsaturated compound.

Further disclosed herein is a method for quantification of depolymerized species in metathesis oil composition produced from olefin cross metathesis of a polymeric material and an unsaturated compound comprising: a) dissolving the metathesis oil with a solvent to form a first solution; b) filtering the first solution and removing at least a portion of insoluble species in the metathesis oil thereby forming a second solution; c) testing the second solution in a gel permeation chromatogram (GPC) equipped with band-filter based detector, wherein the GPC comprises peaks and shoulders; d) calibrating a GPC column with mono-dispersed polystyrene standards with a molecular weight in a range from 300 to 10 M; e) calibrating the band-filter based detector for mass quantification with polystyrene, polyisoprene, and polybutadiene; f) calibrating the band-filter based detector for comonomer or C₂ content with ethylene-propylene copolymer or a mixture ethylene-propylene copolymer with polyethylene, polypropylene, and EP in which a C₂ content is pre-determined from nuclear magnetic resonance (NMR) or Fourier transform infrared measurements; g) converting the GPC measured in c) into molecular weight distribution based on the GPC column calibration in d); h) determining a C₂ content as a function of molecular weight for the metathesis oil composition based on a comonomer calibration in f); i) assigning the peaks and shoulders in the GPC in c) to one or more species selected from the group consisting of butadiene, styrene monomer, isoprene monomer, dimers thereof, copolymers thereof, and combinations thereof based on a value of molecular weight and C₂% content for the species; j) calculating a peak area and a peak area fraction by fitting the peaks and shoulders in the GPC with a multiple lognormal function; k) converting the peak area fraction into mass fraction based on the calibration in e), l) calculating a yield of solvent extractable portion of the metathesis oil; and m) calculating a yield of each species in the metathesis oil.

These and other features and attributes of the disclosed methods for chemically recycling tires produce recycled tire materials including reclaimed carbon black of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 is a transmission electro micrograph of metathesis carbon black produced in accordance with certain embodiments of the present disclosure.

FIG. 2 is a transmission electro micrograph of tire pyrolysis carbon black produced in accordance with certain embodiments of the present disclosure.

FIG. 3 is a high-angle annular dark-field scanning transmission electron (HAADF) micrograph of metathesis carbon black produced in accordance with certain embodiments of the present disclosure.

FIG. 4 is a HAADF micrograph of metathesis carbon black produced in accordance with certain embodiments of the present disclosure.

FIG. 5 is an annular dark-field scanning transmission electron microscopy (ADF) micrograph of metathesis carbon black produced in accordance with certain embodiments of the present disclosure.

FIG. 6 is an electron energy loss spectroscopy (EELS) mapping micrograph of metathesis carbon black produced in accordance with certain embodiments of the present disclosure.

FIG. 7 is a combination HAADF and EELS micrograph of tire pyrolysis carbon black produced in accordance with certain embodiments of the present disclosure.

FIG. 8 is a schematic illustration of an experimental setup for collecting products after depolymerization in a twin screw reactive extruder used in in accordance with certain embodiments of the present disclosure.

FIG. 9 is an x-ray diffractogram of metathesis carbon black produced in accordance with certain embodiments of the present disclosure.

FIG. 10 is an x-ray diffractogram of virgin carbon black in accordance with certain embodiments of the present disclosure.

FIG. 11 is a graph of tensile strain versus tensile strength for polymers prepared with various types of carbon black produced in accordance with certain embodiments of the present disclosure.

FIG. 12 is a graph of temperature variance of tan S for various carbon blacks produced in accordance with certain embodiments of the present disclosure.

FIG. 13 is a schematic illustration of sample preparation for a gel permeation chromatography/infrared spectrometry test used in in accordance with certain embodiments of the present disclosure.

FIG. 14 is a gel permeation chromatogram showing the detector intensity as a function of elution volume for metathesis oil produced in accordance with certain embodiments of the present disclosure.

FIG. 15 is a GPC plot showing the molecular weight distribution and the C₂% content vs. molecular weight for metathesis oil produced in accordance with certain embodiments of the present disclosure.

### DETAILED DESCRIPTION

Disclosed herein are methods of recycling tires, and, more particularly, disclosed are methods of chemically recycling tires using a depolymerization catalyst to produce recycled tire materials. The methods generally include contacting a polymeric material such as tire particles with an unsaturated hydrocarbon in the presence of an olefin cross metathesis catalyst and reacting the unsaturated compound with the tire particles to produce an olefin cross metathesis product containing oligomers of tire rubber components including, but not limited to, natural rubber (NR) oligomers such as polyisoprene, butyl rubber (BR) oligomers, and styrene-butadiene rubber (SBR) oligomers, collectively referred to as metathesis oil (mOil), and metathesis carbon black (mCB). Inorganic tire additives such as silica (SiO₂) can be reclaimed from the tire in virgin form. The metathesis reaction occurs in mild conditions, typically below 100° C., such that the morphology of the carbon black remains the same as the carbon black used for production of the tire. The methods can be carried out continuously or in batch mode as will be described below.

In embodiments, polymeric materials which can be depolymerized include, without limitation, natural and synthetic elastomers such as polymers with unsaturated backbone including butadiene rubbers, butyl rubbers, isoprene rubber, nitrile rubber, polychloroprene (neoprene), styrene butadiene rubber, polyalkenamers, copolymers of alkenes with conjugated dienes, their functionalized versions and combinations thereof. In embodiments, some specific polymeric materials which can be depolymerized in the present process include, without limitation, rubber tire materials such as rubber tires, rubber tire scraps, ground rubber tire materials, tire rubber powder, and the like. In embodiments the polymeric materials include fillers such as which include, without limitation, carbon black, silica, carbon, chalk (calcium carbonate), zinc oxide, for example. Tires are often manufactured contain a mix of natural and synthetic rubber which form a polymer matrix to which fillers are added to reinforce the polymer matrix. Selection of filler materials affects the strength, resilience, and wear properties of the tire with each tire typically containing 20-60 by weight filler material. Carbon black filler is often used as a large component of tires with various grades of carbon black being blended to achieve desired properties of the final cured rubber. Carbon black grades are classified in ASTM D1765-21 titled “Standard Classification System for Carbon Blacks Used in Rubber Products” which includes various grades such as N115, N121, N220, N230, N300, N330, N550, N660, N772, and N774 for example. Tires also typically contain reinforcement materials such as steel, polyester, rayon, nylon, and polyaramid as well as plasticizers such as oils and resins, vulcanization chemicals such as sulfur and zinc oxide, as well as anti-aging chemicals. The disclosed methods of chemically recycling tires are not limited to any particular type of tire and can readily be applied to any type of tire with any mixture of fillers and additives and with any grades of carbon black.

There are several suitable chemical routes to depolymerize the polymeric material, only some of which are alluded to herein. One method to depolymerize the polymeric material includes contacting the polymeric material with an unsaturated compound in the presence of an olefin cross metathesis catalyst and reacting the unsaturated compound with polymeric material in an olefin cross metathesis reaction. The olefin cross metathesis reaction involves chain scission across a carbon-carbon double bond of the polymeric material and the unsaturated compound followed by rearrangement of the fractions of the polymeric material and unsaturated compound to form the olefin cross metathesis product. The chemical identity of the olefin cross metathesis product depends on the chemical identity of the starting polymeric material and unsaturated compound and may include various oligomers of butadiene rubbers, butyl rubbers, isoprene rubber, nitrile rubber, polychloroprene (neoprene), styrene butadiene rubber, polyalkenamers, copolymers of alkenes with conjugated dienes, their functionalized versions and cross-metathesis combinations thereof, for example.

In embodiments, the unsaturated compound can include any hydrocarbon compound with at least one unsaturated bond. Some suitable unsaturated compounds include, without limitation, un-hydrogenated polymer waxes such as polyethylene wax and polypropylene wax, steam cracker tar, unsaturated solid resin such as vinyl esters, unsaturated polyoctene, vinyl cyclohexene, styrene, and unsaturated poly alpha olefins. In some embodiments, unsaturated compounds can be treated to increase the concentration of unsaturated bonds. For example, polyethylene and polypropylene can be thermally degraded under pyrolysis conditions to form polyethylene wax containing a mixture of alkanes, alkenes, and alkynes. In embodiments, the unsaturated compound can include an unsaturated compound with a carbon number in a range of C₂ to C₈₀. For example, the unsaturated compound can include ethylene, propylene, 1-butene, 2-butene, butadiene, cyclopentene, cyclohexene, cyclohexadiene, and combinations thereof. In further embodiments, unsaturated compounds can include, without limitation, vinyl monomers, (meth)acryl monomers, unsaturated hydrocarbon monomers, and ethylenically-terminated oligomers. Examples of such monomers include, generally, mono- or polyvinylbenzenes, mono- or polyisopropenylbenzenes, mono- or polyvinyl(hetero)aromatic compounds, mono- or polyisopropenyl(hetero)aromatic compounds, alkylene di(meth)acrylates, bisphenol A di(meth)acrylates, benzyl (meth)acrylates, phenyl(meth)acrylates, heteroaryl (meth)acrylates, terpenes (e.g., squalene) and carotene. Ethylenically unsaturated monomers include a (hetero)aromatic moiety such as, for example, phenyl, pyridine, triazine, pyrene, naphthalene, or a polycyclic (hetero)aromatic ring system, bearing one or more vinylic, acrylic or methacrylic substituents. Examples of such monomers include benzyl (meth)acrylates, phenyl (meth)acrylates, divinylbenzenes (e.g., 1,3-divinylbenzene, 1,4-divinylbenzene), isopropenylbenzene, styrenics (e.g., styrene, 4-methylstyrene, 4-chlorostyrene, 2,6-dichlorostyrene, 4-vinylbenzyl chloride), diisopropenylbenzenes (e.g., 1,3-diisopropenylbenzene), vinylpyridines (e.g., 2-vinylpyridine, 4-vinylpyridine), 2,4,6-tris((4-vinylbenzyl)thio)-1,3,5-triazine and divinylpyridines (e.g., 2,5-divinylpyridine). In certain embodiments, the one or more ethylenically unsaturated monomers (e.g., including an aromatic moiety) bears an amino (i.e., primary or secondary) group, a phosphine group or a thiol group. One example of such a monomer is vinyldiphenylphosphine. In embodiments, the unsaturated compound is in a gaseous phase, a gaseous unsaturated compound, or in a solid phase, a solid unsaturated compound.

In embodiments, the olefin cross metathesis catalyst includes catalysts such as organomolybdenum, organotungsten, or organoruthenium. Some specific catalysts include Schrock and Grubbs catalysts such as Grubbs Catalyst® 1^{st} and 2^{nd} generations, or the Hoveyda-Grubbs Catalyst® and analogs thereof. In embodiments, the catalyst can include any of dichloro(3-phenyl-1H-inden-1-ylidene)bis(tricyclohexylphosphine)ruthenium(II), benzylidene-bis(tricyclohexylphosphine)dichlororuthenium, dichloro[1,3-bis(2,4,6-trimethylphenyl)-2-imidazolidinylidene](3-phenyl-1H-inden-1-ylidene)(tricyclohexylphosphine)ruthenium(II), benzylidene[1,3-bis(2,4,6-trimethylphenyl)-2-imidazolidinylidene]dichloro(tricyclohexylphosphine)ruthenium, (1,3-Bis-(2,4,6-trimethylphenyl)-2-imidazolidinylidene)dichloro(o-isopropoxyphenylmethylene)ruthenium, Dichloro[1,3-bis(2,6-isopropylphenyl)-2-imidazolidinylidene](2-isopropoxyphenylmethylene)ruthenium(II), dichloro[1,3-bis(2,4,6-trimethylphenyl)-2-imidazolidinylidene][(2-isopropoxy)(5-trifluoroacetamido)benzylidene]ruthenium(II), and combinations thereof.

In embodiments, the depolymerization reaction can be performed with any suitable weight a weight ratio of unsaturated compound to polymeric material. In embodiments, the unsaturated compound is present in an amount of 1 wt % to 50 wt % of the polymeric material. Alternatively, from 1 wt % to 10 wt % of the polymeric material, from 10 wt % to 20 wt % of the polymeric material, from 20 wt % to 30 wt % of the polymeric material, from 30 wt % to 40 wt % of the polymeric material, from 40 wt % to 50 wt % of the polymeric material, or any ranges therebetween.

In embodiments, the olefin cross metathesis catalyst is present in any suitable weight ratio of olefin cross metathesis catalyst to polymeric material. In embodiments, the olefin cross metathesis catalyst is present in an amount of 0.001 wt % to 10 wt % of the polymeric material. Alternatively, from 0.001 wt % to 0.01 wt % of the polymeric material, from 0.1 wt % to 0.5 wt % of the polymeric material, 0.5 wt % to 1 wt % of the polymeric material, 1 wt % to 2 wt % of the polymeric material, 2 wt % to 3 wt % of the polymeric material, 4 wt % to 5 wt % of the polymeric material, 5 wt % to 7 wt % of the polymeric material, 7 wt % to 10 wt % of the polymeric material, or any ranges therebetween.

In batch and semi-batch embodiments, the unsaturated compound is mixed with the polymeric material and olefin cross metathesis catalyst to depolymerize the polymeric material thereby forming metathesis oil (mOil) and metathesis carbon black (mCB). The olefin cross metathesis reaction can be carried out in a batch, semi-batch, or continuous process as will be described below. In the batch embodiments, the unsaturated compound, polymeric material, and olefin cross metathesis catalyst are introduced into a batch-type reactor and allowed to react. Optionally, additional unsaturated compound, polymeric material, and/or olefin cross metathesis catalyst is added to the reactor after the olefin cross metathesis reaction has started in semi-batch embodiments. In batch and semi-batch processes the reactants may be agitated such as by stirring to promote mixing. The reaction may be carried out for any suitable amount of time to produce the mOil and mCB whereafter the mOil and mCB are removed from the reactor for further processing. In embodiments, the reactor includes a pressure vessel, and the unsaturated compound includes a compound, such as propylene or butene, which is gaseous at reaction conditions.

In batch and semi-batch embodiments, the reactor is operated at olefin cross metathesis conditions, including a suitable pressure and temperature to form the metathesis oil (mOil) and metathesis carbon black (mCB). In embodiments, the reactor is operated at a pressure between 1 bar and 50 bar. Alternatively, at a pressure between 1 bar and 10 bar, 10 bar to 20 bar, 20 bar to 30 bar, 30 bar to 40 bar, 40 bar to 50 bar, or any ranges therebetween. In embodiments, the reactor is operated at a temperature between 10° C. to 300° C. Alternatively, at a temperature between 10° C. to 50° C., at a temperature between 50° C. to 100° C., at a temperature between 100° C. to 150° C., at a temperature between 150° C. to 200° C., at a temperature between 20° C. to 250° C., at a temperature between 250° C. to 300° C., or any ranges therebetween. In embodiments, the reaction can be carried out for any suitable amount of time such as between 1 minute to 24 hours. Alternatively, 1 minute to 1 hour, from 1 hour to 6 hours, 6 hours to 12 hours, 12 hours to 18 hours, 18 hours to 24 hours, or any ranges therebetween.

In continuous process embodiments, the unsaturated compound is mixed with the polymeric material and olefin cross metathesis catalyst and introduced into a reactive extruder such as a screw extruder. The reactive extruder typically includes a barrel, one or more screws disposed within the barrel, and a drive motor operable to turn the screws within the barrel. The screws typically include different zones for mixing and conveying material through the barrel, where the mixing zones are configured to shear and knead the material to promote thorough mixing. As the mixture passes though the mixing zones, the polymeric material and unsaturated compound are reacted by olefin cross metathesis reaction to produce mOil and mCB. The mOil and mCB pass through the length of the reactive extruder and are collected at the end of the reactive extruder for further processing. The unsaturated compound, polymeric material, and olefin cross metathesis catalyst can be added to the reactive extruder in any order or at any point along the barrel of the reactive extruder. In some embodiments, the unsaturated compound, polymeric material, and olefin cross metathesis catalyst are added all at once to the reactive extruder such as through a feed hopper. In further embodiments, one or more of the unsaturated compound, polymeric material, or olefin cross metathesis catalyst are introduced into the reactive extruder separately. In some embodiments, one or more of the unsaturated compound, polymeric material, or olefin cross metathesis catalyst are introduced into the reactive extruder at multiple locations in the barrel of the reactive extruder.

In embodiments, the unsaturated compound is generated within the reactive extruder, where a thermally de-polymerizable material is thermally depolymerized to form the unsaturated compound. In these embodiments, the thermally de-polymerizable material is introduced into the reactive extruder, along with any other compounds required such as depolymerization catalysts. The depolymerization reaction occurs in the reactive extruder to produce the unsaturated compound which thereafter reacts with the polymeric material as discussed above. Alternatively, the thermally polymeric material can be mixed with any of depolymerization catalysts, unsaturated compound, polymeric material, and olefin cross metathesis catalyst.

In continuous embodiments, the reactive extruder is operated at olefin cross metathesis conditions, including a suitable pressure and temperature to form the metathesis oil (mOil) and metathesis carbon black (mCB). In embodiments, the reactive extruder is operated at a pressure between 50 bar and 350 bar. Alternatively, at a pressure between 70 bar to 120 bar, 120 bar to 200 bar, 200 bar to 350 bar, or any ranges therebetween. In embodiments, the reactive extruder is operated at a temperature between 10° C. to 300° C. Alternatively, at a temperature between 10° C. to 50° C., at a temperature between 50° C. to 100° C., at a temperature between 100° C. to 150° C., at a temperature between 150° C. to 200° C., at a temperature between 20° C. to 250° C., at a temperature between 250° C. to 300° C., or any ranges therebetween. In embodiments, the reactive extruder can be operated with a residence time between 60 seconds to 10 minutes. Alternatively, a residence time between 1 minute to 2 minutes, between 2 minutes to 3 minutes, between 3 minutes to 5 minutes, 5 minutes to 10 minutes, or any ranges therebetween. As mentioned above, the reactive extruder can be any type of screw extruder such as single screw or double screw extruder. The reactive extruder can have any suitable L/D ratio such as between 20:1 to 40:1 or greater.

In embodiments after the depolymerization has been carried out as described above, the product mCB and mOil are further processed to separate the mCB, mOil, and impurities. In embodiments, the mCB is at least partially suspended in the mOil after the depolymerization reaction. A solvent such as a linear, branched, cyclic, or aromatic hydrocarbon with a carbon number from C₆ to C₂₀ is added to the suspension of mCB and mOil to extract the mOil into the solvent. The resulting mixture is further separated by a solids-liquid separation schema such as centrifuging, hydro cyclone, sedimentation, coagulation and flocculation, filtration, pressing, and the like.

### Additional Embodiments

Accordingly, the present disclosure may provide method for recycling polymeric materials, and, more particularly, disclosed are methods of chemically recycling tires using a depolymerization catalyst to produce recycled tire materials. The methods/systems/compositions/tools may include any of the various features disclosed herein, including one or more of the following statements.

Statement 1. A method comprising: introducing a polymeric material, an unsaturated compound, and an olefin cross metathesis catalyst into a reactor, wherein the polymeric material comprises a carbon black filler; reacting at least a portion of the polymeric material with the unsaturated compound in the presence of the olefin cross metathesis catalyst to produce at least metathesis oil and metathesis carbon black, wherein the metathesis oil comprises an olefin cross metathesis product of the polymeric material and the unsaturated compound; and separating at least a portion of the metathesis carbon black.

Statement 2. The method of statement 1 wherein the polymeric material comprises one or more materials selected from the group consisting of butadiene rubbers, butyl rubbers, isoprene rubber, nitrile rubber, polychloroprene, styrene butadiene rubber, polyalkenamers, copolymers of alkenes with conjugated dienes, and combinations thereof.

Statement 3. The method of any of statements 1-2 wherein the polymeric material comprises one or more materials selected from the group consisting of rubber tires, rubber tire scraps, ground rubber tire material, tire rubber powder, and combinations thereof.

Statement 4. The method of any of statements 1-3 wherein the unsaturated compound comprises a material with a carbon number of C₂ to C₈₀ and at least one degree of unsaturation.

Statement 5. The method of any of statements 1-4 wherein the unsaturated compound comprises at least one material selected from the group consisting of polyethylene wax and polypropylene wax, steam cracker tar, vinyl ester, unsaturated polyoctene, vinyl cyclohexene, styrene, unsaturated poly alpha olefin, and combinations thereof.

Statement 6. The method of any of statements 1-5 wherein the unsaturated compound comprises at least one material selected from the group consisting of ethylene, propylene, 1-butene, 2-butene, butadiene, cyclopentene, cyclohexene, cyclohexadiene, and combinations thereof.

Statement 7. The method of any of statements 1-6 wherein the metathesis catalyst comprises at least one catalyst selected from the group consisting of organomolybdenum, organotungsten, organoruthenium, and combinations thereof.

Statement 8. The method of any of statements 1-7 wherein the metathesis catalyst comprises at least one catalyst selected from the group consisting of dichloro(3-phenyl-1H-inden-1-ylidene)bis(tricyclohexylphosphine)ruthenium(II), benzylidene-bis(tricyclohexylphosphine)dichlororuthenium, dichloro[1,3-bis(2,4,6-trimethylphenyl)-2-imidazolidinylidene](3-phenyl-1H-inden-1-ylidene)(tricyclohexylphosphine)ruthenium(II), benzylidene[1,3-bis(2,4,6-trimethylphenyl)-2-imidazolidinylidene]dichloro(tricyclohexylphosphine)ruthenium, (1,3-Bis-(2,4,6-trimethylphenyl)-2-imidazolidinylidene)dichloro(o-isopropoxyphenylmethylene)ruthenium, Dichloro[1,3-bis(2,6-isopropylphenyl)-2-imidazolidinylidene](2-isopropoxyphenylmethylene)ruthenium(II), dichloro[1,3-bis(2,4,6-trimethylphenyl)-2-imidazolidinylidene][(2-isopropoxy)(5-trifluoroacetamido)benzylidene]ruthenium(II), and combinations thereof.

Statement 9. The method of any of statements 1-8 wherein reacting at least the portion of the polymeric material with the unsaturated compound in the presence of the olefin cross metathesis catalyst comprises reacting at a temperature of about 10° C. to about 50° C.

Statement 10. The method of any of statements 1-9 wherein reacting at least the portion of the polymeric material with the unsaturated compound in the presence of the olefin cross metathesis catalyst comprises reacting at a pressure of about 1 bar to about 20 bar.

Statement 11. A method comprising: introducing a polymeric material, an unsaturated compound, and an olefin cross metathesis catalyst into a screw extruder, wherein the polymeric material comprises a carbon black filler; mixing the polymeric material and the unsaturated compound in a mixing zone in the screw extruder; reacting at least a portion of the polymeric material with the unsaturated compound in the presence of the olefin cross metathesis catalyst to produce at least metathesis oil and metathesis carbon black, wherein the metathesis oil comprises an olefin cross metathesis product of the polymeric material and the unsaturated compound; and separating at least a portion of the metathesis carbon black.

Statement 12. The method of statement 11 wherein the polymeric material comprises one or more materials selected from the group consisting of butadiene rubbers, butyl rubbers, isoprene rubber, nitrile rubber, polychloroprene, styrene butadiene rubber, polyalkenamers, copolymers of alkenes with conjugated dienes, and combinations thereof.

Statement 13. The method of any of statements 11-12 wherein polymeric material comprises one or more materials selected from the group consisting of rubber tires, rubber tire scraps, ground rubber tire material, tire rubber powder, and combinations thereof.

Statement 14. The method of any of statements 11-13 wherein the unsaturated compound comprises a material with a carbon number of C₂ to C₈₀ and at least one degree of unsaturation.

Statement 15. The method of any of statements 11-14 wherein the metathesis catalyst comprises at least one catalyst selected from the group consisting of organomolybdenum, organotungsten, organoruthenium, and combinations thereof.

Statement 16. A method comprising: introducing a polymeric material, a gaseous unsaturated compound, and an olefin cross metathesis catalyst into a reactor, wherein the polymeric material comprises a carbon black filler; reacting at least a portion of the polymeric material with the gaseous unsaturated compound in the presence of the olefin cross metathesis catalyst at a temperature of about 10° C. to about 100° C. to produce at least metathesis oil and metathesis carbon black, wherein the metathesis oil comprises an olefin cross metathesis product of the polymeric material and the gaseous unsaturated compound; and separating at least a portion of the metathesis carbon black.

Statement 17. The method of statement 16 wherein the polymeric material comprises one or more materials selected from the group consisting of butadiene rubbers, butyl rubbers, isoprene rubber, nitrile rubber, polychloroprene, styrene butadiene rubber, polyalkenamers, copolymers of alkenes with conjugated dienes, and combinations thereof.

Statement 18. The method of any of statements 16-17 wherein polymeric material comprises one or more materials selected from the group consisting of rubber tires, rubber tire scraps, ground rubber tire material, tire rubber powder, and combinations thereof.

Statement 19. The method of any of statements 16-18 wherein the gaseous unsaturated compound comprises at least one material selected from the group consisting of ethylene, propylene, 1-butene, 2-butene, butadiene, and combinations thereof.

Statement 20. The method of any of statements 16-19 wherein the metathesis catalyst comprises a catalyst selected from the group consisting of organomolybdenum, organotungsten, organoruthenium, and combinations thereof.

Statement 21. A metathesis oil composition comprising the olefin cross metathesis product of the polymeric material and the unsaturated compound of statement 1.

Statement 22. A method for quantification of depolymerized species in metathesis oil composition produced from olefin cross metathesis of a polymeric material and an unsaturated compound comprising: a) dissolving the metathesis oil with a solvent to form a first solution; b) filtering the first solution and removing at least a portion of insoluble species in the metathesis oil thereby forming a second solution; c) testing the second solution in a gel permeation chromatogram (GPC) equipped with band-filter based detector, wherein the GPC comprises peaks and shoulders; d) calibrating a GPC column with mono-dispersed polystyrene standards with a molecular weight in a range from 300 to 10 M; e) calibrating the band-filter based detector for mass quantification with polystyrene, polyisoprene, and polybutadiene; f) calibrating the band-filter based detector for comonomer or C₂ content with ethylene-propylene copolymer or a mixture ethylene-propylene copolymer with polyethylene, polypropylene, and EP in which a C₂ content is pre-determined from nuclear magnetic resonance (NMR) or Fourier transform infrared measurements; g) converting the GPC measured in c) into molecular weight distribution based on the GPC column calibration in d); h) determining a C₂ content as a function of molecular weight for the metathesis oil composition based on a comonomer calibration in f); i) assigning the peaks and shoulders in the GPC in c) to one or more species selected from the group consisting of butadiene, styrene monomer, isoprene monomer, dimers thereof, copolymers thereof, and combinations thereof based on a value of molecular weight and C₂% content for the species; j) calculating a peak area and a peak area fraction by fitting the peaks and shoulders in the GPC with a multiple lognormal function; k) converting the peak area fraction into mass fraction based on the calibration in e), l) calculating a yield of solvent extractable portion of the metathesis oil; and m) calculating a yield of each species in the metathesis oil.

To facilitate a better understanding of the present invention, the following examples of certain aspects of some embodiments are given. In no way should the following examples be read to limit, or define, the entire scope of the disclosure.

### EXAMPLES

### Example 1—Propenolysis

In this example, tire granules were depolymerized in a batch process using an olefin metathesis catalyst and propylene. A 53-gram aliquot of super fine tire rubber powder (sourced from Genan) was mixed with 0.45 g of metathesis catalyst in a 250 mL Fisher-Porter bottle. The metathesis catalyst used was Hoveyda-Grubbs Catalyst® M73 SIPr (dichloro[1,3-bis(2,6-diisopropylphenyl)imidazolidin-2-ylidene][(5-isobutoxycarbonylamino)-(2-isopropoxy)benzylidene]ruthenium(II)). The bottle was pressurized with propylene to a pressure of 827 kPa (120 psi) and kept at a temperature of 25° C. for a period of 12 hours to allow the metathesis reaction to progress. At the end of the 12-hour period, a liquid oil was observed to have formed. Thereafter, the oligomeric products were extracted into toluene (200 mL) and the resulting suspension was centrifuged. The precipitate obtained from centrifuging was washed with toluene, re-centrifuged, and dried. After drying the metathesis carbon black (mCB) weighed 26.7 g. The toluene from extraction and washing were combined and evaporated thereby yielding 23.71 g of a dark brown metathesis oil (mOil).

It was observed that about 50 wt % of tire granules were converted into mCB by the metathetic depolymerization. Since various grades of carbon black are used for the production of tires along with inorganic components, it is assumed that mCB contains the mixture of carbon black grades with inorganic components.

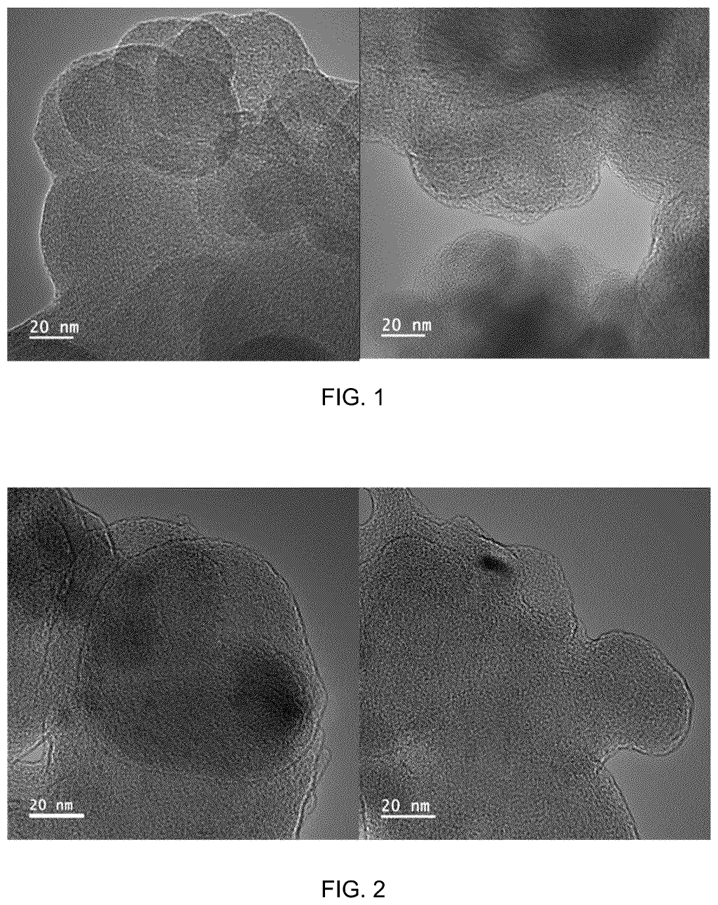

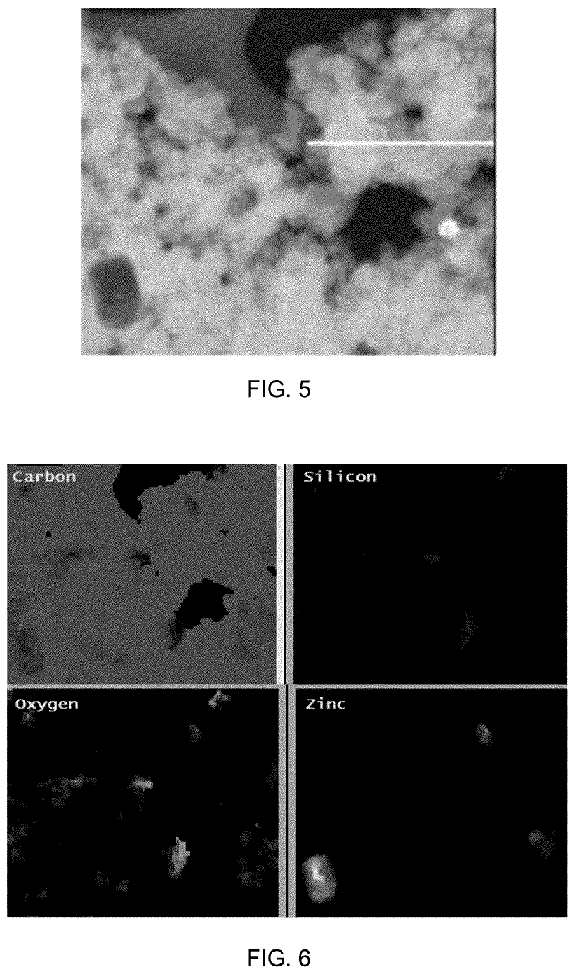

A transmission electron micrograph (TEM) was captured for the mCB and is shown in FIG. 1. For comparison, a transmission electron micrograph was captured for recycled carbon black (rCB) produced from tire pyrolysis (N300 sourced from Klean Industries) and is shown in FIG. 2. It was observed that the TEM for mCB shows the formation of particles with a morphology, typical for commercial carbon black, where well-resolved layers of sp²-hybridized carbon atoms are wrapped around the center of the particle. The shape and surface appearance of mCB particles are different compared to that observed for the rCB. It was observed that the TEM for rCB shows a less uniform composition than for mCB which can be attributed to substantially different conditions employed in metathesis and tire pyrolysis recovery processes of carbon black.

A compositional analysis was performed on the mCB and pCB, the results of which are shown in Table 1. It was observed that both the mCB and pCB contained a fraction of various elements other than carbon. It was observed that the carbon content of the metathesis carbon black was higher than the tire pyrolysis carbon black.

TABLE 1

| | Metathesis Carbon | Tire Pyrolysis Carbon |
|---|---|---|
| | Black (wt %) | Black (wt %) |
| Carbon | 85.14 | 79.47 |
| Hydrogen | 4.05 | 0.76 |
| Nitrogen | 0.78 | 0.33 |
| Oxygen | 6.07 | 3.27 |
| Sulfur | 1.92 | 2.57 |

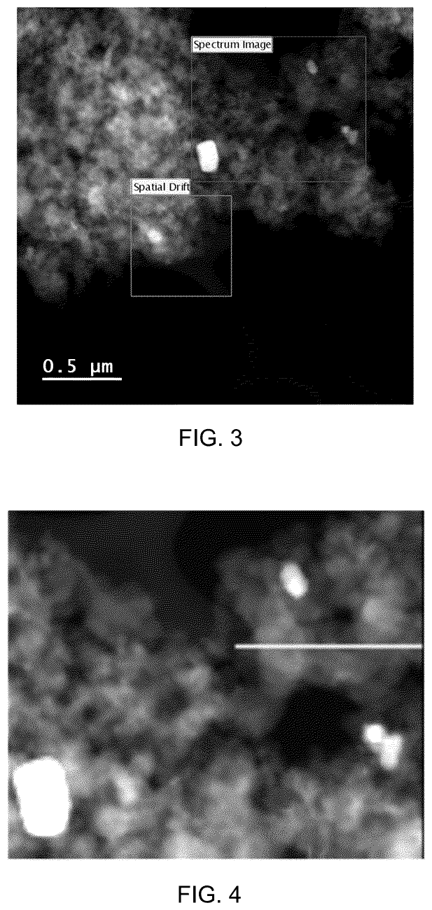

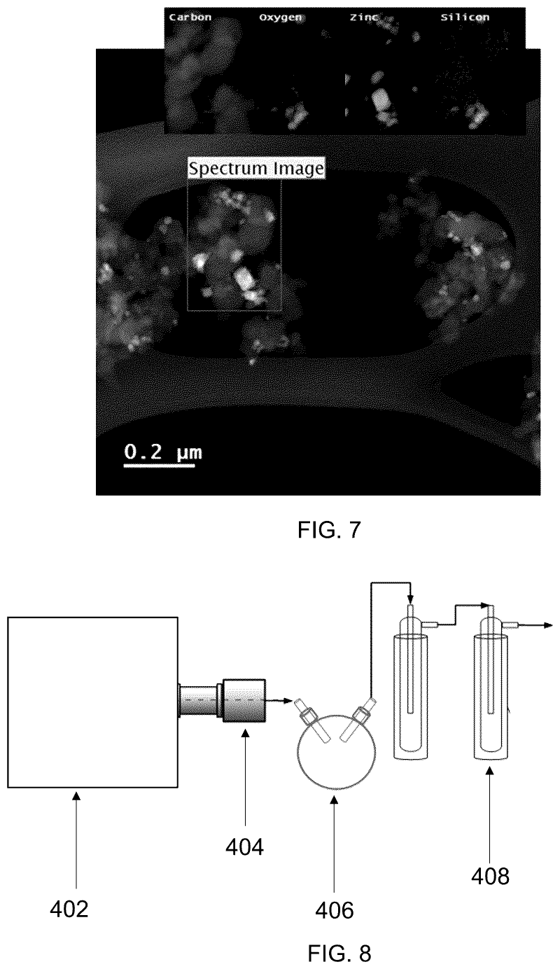

Further compositional analysis of the mCB and pCB was performed using high-angle annular dark-field scanning transmission electron microscopy (HAADF), annular dark-field scanning transmission electron microscopy (ADF), and electron energy loss spectroscopy (EELS) mapping. FIGS. 3 and 4 are HAADF micrographs of mCB, FIG. 5 is an EELS mapping micrograph of mCB, and FIG. 6 is an ADF micrograph of mCB. FIG. 7 is a combination HAADF and EELS micrograph of pCB. It was observed that for both the mCB and pCB that mineral intrusion from ZnS and SiO₂ was present in the carbon black matrix.

### Example 2—Butenolysis

In this example, tire granules were depolymerized in a batch process using an olefin metathesis catalyst and 2-butene. A 100-gram aliquot of super fine tire rubber powder (sourced from Genan) was mixed with 1.00 g of M73-SiPr in 500 mL Fisher-Porter bottle. A 40 mL aliquot of 2-butene was condensed to the bottle at −80° C. The resulting mixture was agitated for 12 hours at the ambient temperature. Then, unreacted 2-butene was vented out and toluene (300 mL) was added to the resulting mixture. mCB and oligomers were separated by centrifuging. After the evaporation of volatiles 48.0 g of mCB and 47.5 g of mOil were obtained.

### Example 3—Continuous Process

In this example, tire granules were depolymerized in a continuous process using a screw extruder. FIG. 8 is a schematic illustration of the experimental setup used in this example. Twin screw extruder 402 is fed with a mixture of tire rubber powder, wax, and catalyst and mixes within mixing zones in twin screw extruder 402. The depolymerized tire is extruded through die 404 into collection vessel 406. Cold trap 408 is connected to collection vessel 406 and is kept under dynamic vacuum.

A mixture containing 90 wt % super fine tire rubber powder (sourced from Genan), 9.1 wt % unsaturated wax containing linear internal olefins with carbon numbers ranging from C₂₄-C₃₄, and 0.9 wt % M73-SiPr metathesis catalyst was prepared. The mixture was continuously fed into the twin screw extruder held at 80° C. and 200 RPM with a mean residence time of 10 minutes. Table 2 shows the process conditions used for this example.

TABLE 2

| | | |
|---|---|---|
| Tire Granules | wt % | 90 |
| Catalyst | wt % | 0.9 |
| C₂₄-C₃₄ Olefinic wax | wt % | 9.1 |
| Catalyst/Tire Granules | mg/g | 10 |
| Actual Feed Rate | g/hr | 64 |
| RPM | | 200 |
| Set Temperature | | |
| Barrel #1 | ° C. | 30 |
| Barrel #2 | ° C. | 50 |
| Barrel #3 | ° C. | 75 |
| Barrel #4 | ° C. | 85 |
| Barrel #5 | ° C. | 85 |
| Barrel #6 | ° C. | 85 |
| Barrel #7 | ° C. | 85 |
| Die | ° C. | 85 |
| Flask - Bowel | ° C. | 90 |
| Tubing - Tracking | ° C. | 90 |

A total of 54.6 g of depolymerized product was obtained. The depolymerized product was suspended in 200 mL of hexane and sonicated for 5 minutes. Then, insoluble products were separated by centrifuging to yield 13.48 g of unreacted tire granules and 13.11 g of mCB further separated by passing through sieves. The evaporation of volatiles from the soluble fraction yielded 24.58 g of mOil.

### Example 4—Prepared Rubber

To investigate the impact of the metathetical depolymerization process on the morphology of carbon black, a natural rubber was cured with only N330 grade virgin carbon black and the resulting cured polymer was used in metathetical degradation.

Vulcanized/cured natural rubber was prepared using a formulation shown in Table 3 shown in grams of additive per 100 grams of rubber. A two-stage mixing process, involving a 1^{st} and 2^{nd} pass non-productive mix and a 3^{rd} pass productive mix, was carried out using an IntelliTorque Brabender® on a 66 gram basis. The 1^{st} non-productive pass initial conditions were 35 RPMs (round-per-minute) and 75° C. for the initial addition of the polymer or polymers. Once the polymer was added to the mixing head, RPMs were increased to 50, after which half the carbon black loading was added over two minutes of mixing, followed by addition of first antioxidant (1,3-dimethylbutyl)-N′-phenyl-p-phenylenediamine and second antioxidant poly(1,2-dihydro-2,2,4-trimethyl-quinoline), ZnO, stearic acid, oil, and wax over 30 seconds, followed by the second half of the carbon black loading over 2 minutes. After the second half of the carbon black loading was added, RPMs were increased to 100 and the mixture was allowed to mix for 8 minutes or until a mixture achieved the temperature of 150° C., whichever came first. Then, the polymer mixture was dumped from the Brabender® and cold pressed. The 2^{nd} non-productive pass involves an initial Brabender® condition of 35 RPM and 75° C. The productive mix from the 1^{st} pass was added back into the Brabender® and the RPMs were increased to 100 RPM and the polymer mixture was allowed to mix for 3 minutes or until the polymer mixture reached a temperature of 150° C., after which the mixture was dumped and cold pressed. Here the amount of polymer mixture added is denoted as the non-productive master batch. The 3^{rd} pass productive mix involved an initial Brabender® setting of 35 RPM and 75° C. The polymer mixture was added over the course of 30 seconds, then the cure package components comprising 1 gram N-tertiarybutyl-2-benzothiazole sulfenamide and 2 grams of sulfur were added to the polymer mixture in the Brabender® over the course of 1.5 minutes. After the cure package was added, the RPMs were increased to 50 RPM and allowed to mix for 3 minutes. The RPMs were adjusted to keep the mixing temperature below 100° C. After 3 minutes the cured polymer was dumped and cold pressed.

TABLE 3

| | |
|---|---|
| Natural Rubber | 100 |
| Carbon black N330 | 50 |
| Naphthenic Oil | 5 |
| Paraffin Wax | 1 |
| Microcrystalline Wax | 2 |
| Stearic acid | 2 |
| First Antioxidant | 3.5 |
| Second Antioxidant | 1.5 |
| Zinc Bar (80% ZnO) | 3 |

Granules of cured polymer (68 g) and M73-SIPr (0.5 g) metathesis catalyst were combined in a 250 mL Fischer-Porter bottle. Toluene (50 mL) was added, and the bottle was pressurized with propylene to 965 kPa (140 psi) and stirred for 2 days at ambient temperature. Then, the oligomeric products and mCB were separated by centrifuging. After removal of volatiles and drying 38.35 g of mOil and 21.5 g of mCB were isolated.

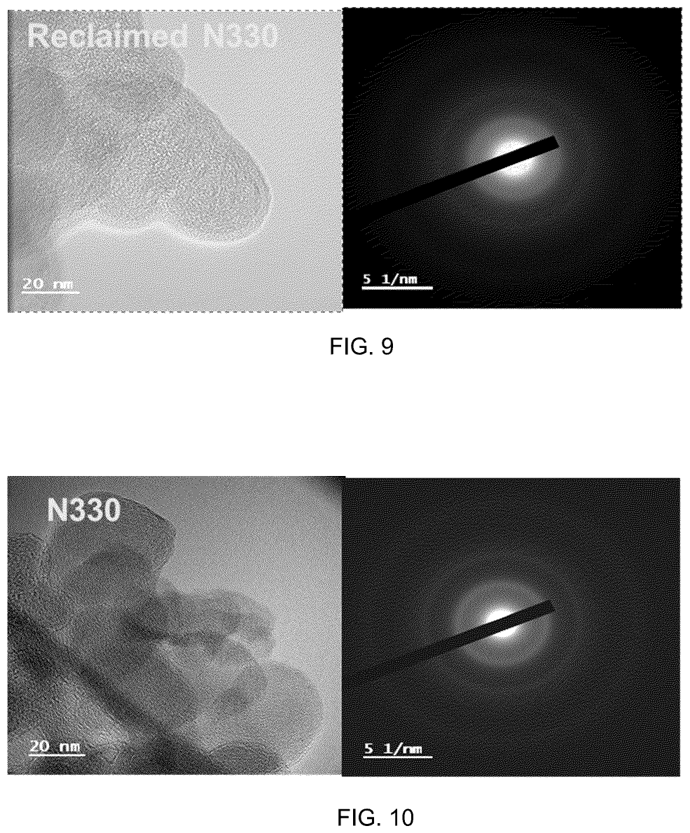

X-Ray diffraction (XRD) analysis was performed on virgin N330 carbon black and reclaimed carbon black (mCB) from the cured polymer. The results of the XRD are shown in FIG. 9 for reclaimed carbon black and FIG. 10 for virgin carbon black. It was observed that the mCB contains a thin layer of absorbed molecules which are believed to be the oligomers of natural rubber. Both recovered and virgin carbon black demonstrate virtually the same X-ray diffraction patterns due to identical carbonaceous morphology. Thus, this observation illustrates that the disclosed metathesis depolymerization process does not alter the molecular structure of carbon black due to mild reaction conditions.

### Example 5—Tensile Strain

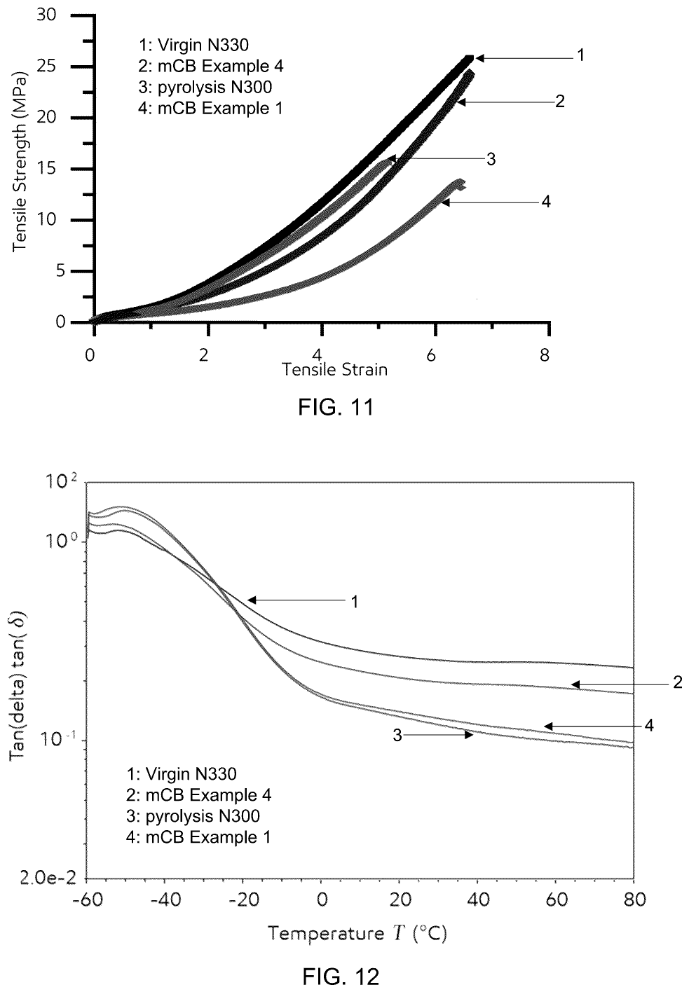

In this example, polymers were prepared with various carbon blacks using the method of Example 4. The tensile strain versus tensile strength was measured for polymers prepared with virgin N330 carbon black, commercial tire pyrolysis recovered N300 carbon black, mCB recovered from tires from Example 1, and mCB recovered from granules of cured polymer from Example 4. The results of the tensile strength are shown in FIG. 11. Tests were performed to determine temperature variance of tan δ for various carbon blacks shown in FIG. 12. The overall performance of N330 carbon black reclaimed by metathetical deconstruction and then re-cured again with natural rubber, is similar to the performance of virgin carbon black. Thus, these experimental details show that mCB can compete with pCB.

### Example 6

One of the challenges of using the mOil produced by the metathesis reaction disclosed herein is that the depolymerized product is a complex mixture including various oligomers and copolymers of styrene, butadiene, isoprene, etc. with a wide range of molecular weight and varying unsaturation. The complex mixture precludes analysis by conventional techniques such as nuclear magnetic resonance (NMR) spectroscopy, gas chromatography (GC), liquid chromatography—mass spectrometry (LC), and solvent extraction methods as these techniques are typically limited by separation capability.

In this example, the analysis problem is solved by integrating sample preparation, separation, characterization with experimental design and detailed data analysis. The designed protocol of experiment takes advantage of advanced functions of a PolymerChar GPC-IR® instrument and some unique features of the detectors. Through mathematical analysis, good quantification about the yield and composition of individual components can be determined. PolymerChar GPC-IR® is a state-to-art GPC (gel permeation chromatography) technique equipped with band-filter based IR5 detector, provides an excellent opportunity to characterize polyolefin across the full molecular weight range due to higher detector sensitivity, stability and better linearity than the refractive-index based detector (DRI) used in traditional GPCs. PolymerChar GPC-IR® also carries some advanced features that other GPCs do not have such as automatic sample dissolution, programmable dissolution time and solvent volume etc. All of these features combined with the non-volatility of GPC mobile phase (tricholorobenzene as a solvent) make it possible to develop a method for accurate composition quantification.

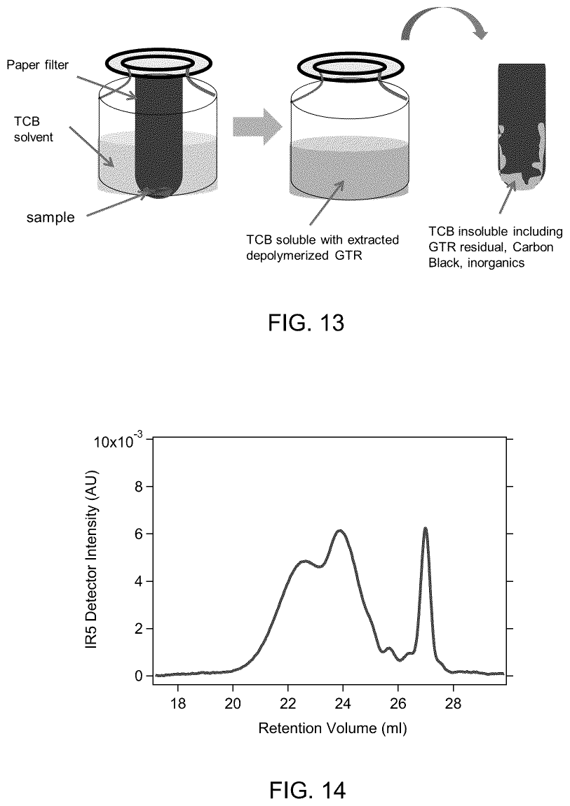

In this example, the sample characterization includes sample dissolution, sample filtration, sample testing (with GPC-IR®) and data analysis. As shown in FIG. 13, the sample dissolution and filtration are performed simultaneously with the depolymerized ground tire rubber sample which is loaded in a thimble filter of ˜5 um pore size. The bottom half of the filter together with the sample is submerged in 10 mL of tricholorobenzene solvent contained in a 20-mL vial. The vial is then put in a shaker oven at 160° C. for 3 hours for hot dissolution or kept at room temperature overnight for cold dissolution. After the dissolution, part of the solution (˜5 mL) in the 20-mL vial is dispensed into a 10-mL vial to prepare for GPC-IR® test. Only the mass of the depolymerized ground tire rubber sample and the mass of solution sample are measured and used in the calculation.

FIG. 14 is a gel permeation chromatogram showing the detector intensity as a function of elution volume for metathesis oil produced. The peaks correspond to the components in the depolymerized products. As part of the data analysis, the peaks must be identified to provide quantification about them. To achieve this, several types of calibration are needed including column calibration, mass calibration and comonomer calibration. For the column calibration, a series of mono-dispersed polystyrene (PS) standards with molecular weight ranging from 300 to 10 million are used. The calibration curve is represented by a quadratic function fit from the data points about log Mp and retention volume for each standard. For the mass calibration, three commercial polymer standards are adopted: the broad molecular weight PS (nominal M_{w}=300 K, Mₙ=125 K), the PolyButadiene (nominal M_{w}=330 K, Mₙ=93 K) and the PolyIsoprene (nominal M_{w}=1026 K, Mₙ=255.3 K). For the comonomer calibration, there is no well-defined comonomer because the sample is a complicated mixture including at least three comonomer species: styrene, butadiene and isoprene. However, a nominal comonomer such as CH₃/1000 C or simply C₂ wt % can be defined. Despite that, the definition does not have a specific physical meaning, the relative difference about the nominal value can be used to distinguish the comonomer species. The measured mass constants and nominal C₂ wt % content for above polymer standards are shown in Table 4 where PS is polystyrene, PB is polybutadiene, and PI is polyisoprene.

TABLE 4

| | PS | PB | PI |
|---|---|---|---|
| Chemical Structure | —(CH₂—CHC₆H₅)— | —(CH₂—CH═CH—CH₂)- | —(CH₂—C═CHCH₃)— |
| Monomer M_{W} | 104 | 54 | 68 |
| C₂ wt % | 101% | 16% | −11% |
| Mass Constant | 100% | 266% | 400% |
| (relative to PS) | | | |

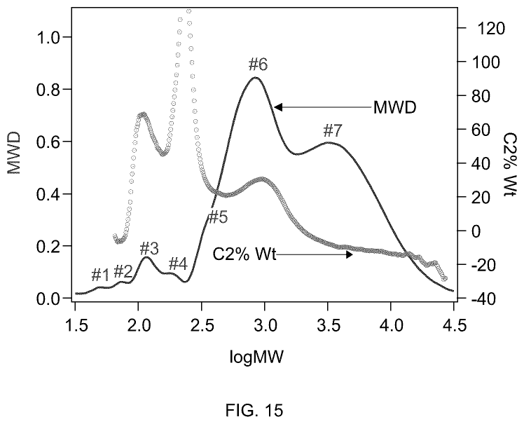

FIG. 15 is a GPC plot showing the molecular weight distribution and the C₂% content vs. molecular weight for metathesis oil produced from a depolymerized ground tire rubber sample at 160° C. With the molecular weight plus the C₂% information obtained from calibration; species can be assigned for the peaks shown in FIG. 15. In FIG. 15, the solid curve is about the molecular weight distribution (MWD) while the dotted curve is about the C₂% content. For example, Peak #1 has a molecular weight of 50 which is very close to the molecular weight of butadiene monomer (B) or 2-butene, therefore it is assigned as butene monomer. Peak #2 has a molecular weight 70 and C₂ content ˜8% which is very close to that for PI monomer (M_{W}=68 and C₂ content=˜11%), therefore it was assigned as polyisoprene (PI) monomer. Same thing is with peak #3 and peak #4. They are assigned as styrene monomer (S) and styrene dimer (2S). Peaks #5 and #6 are assigned as copolymer of styrene butadiene (SB, peak 1 SB1, and peak 2 SB2) because the C₂ content is between PS and PB. Peak #7 is assigned as PI according to the C₂% content. A summary about the peak assignment results is shown in Table 5.

TABLE 5

| | #1 | #2 | #3 | #4 | #5 | #6 | #7 |
|---|---|---|---|---|---|---|---|
| logM_{W} | 1.7 | 1.86 | 2.06 | 2.26 | 2.6 | 2.93 | 3.51 |
| M_{W} | 50 (54) | 72 (68) | 115 (104) | 182 (2*104) | 398 | 851 | 3235 |
| C₂% | | −8% | 70% | 120% | 22% | 30% | −10% |
| Assignment | C₄H₈ (B) | C₅H₈ (PI) | C₈H₈ (S) | (2S) | SB1 | SB2 | PI |

The mass quantification for each component can be performed with the peak area obtained from peak resolution scaled by its mass constants. This is because different species have different detector response and same peak area could correspond to very different amount of mass. The results for the resolved peak area ratio corresponding to each species are shown in Table 6 and the mass fraction are shown in Table 7.

TABLE 6

| Peak area ratio (%) | #1 | #2 | #3 | #4 | #5 | #6 | #7 |
|---|---|---|---|---|---|---|---|
| Assignment | B | IP | S | 2S | SB1 | SB2 | IP |
| mOil (Example 1) | | 3 | 1.9 | 3.9 | 18 | 16.8 | 56.2 |

TABLE 7

| | | | | | | | | Avg. Mass | |
|---|---|---|---|---|---|---|---|---|---|
| | | | | | | | | Cons. | Yield of |
| Wt. % | #1 | #2 | #3 | #4 | #5 | #6 | #7 | (PS = 100%) | extractables |
| Assignment | B | IP | S | 2S | SB1 | SB2 | PI | | |
| mOil (Example 1) | | 2 | 5 | 11 | 21 | 23 | 39 | 291.4 | 33.3% |

The mass constant corresponding to a copolymer can be calculated from the mass constant and the area fraction of each monomer species in it (see Equation 1). Equation 1 can also be used to calculate the average mass constant in a mixture if the mass constant and the area fraction for each individual component is given. In Equation 1, α is the average mass constant, αₗ is the mass constant for component i, and Aᵢ is the individual peak area for component 1.

$$α = {( \sum \frac{{A}_{i}}{{α}_{i}} )}^{- 1} \qquad Equation 1$$

The mass yield of the extractables or the mass fraction of the trichlorobenzene soluble fraction in the whole sample can be calculated from the mass recovery and the average mass constant according to Equation 2 below.

$${R}_{s o l u} = ( 1 + \frac{145 {V}_{0}}{{M}_{s o l u}} ) \frac{{M}_{0}}{{V}_{0}} \frac{M {R}_{s o l u / α} / α}{{M}_{t i τ e} / {V}_{T C B}} \qquad Equation 2$$

where the M₀ is the polymer mass input (in mg) and V₀ is the trichlorobenzene (TCB) volume input (in ml) in the GPC-IR test. V_{TCB} is the total liquid volume in vial for the soluble phase; Mₜᵢᵣₑ and Mₛₒₗᵤ are the mass for the original sample and for the trichlorobenzene soluble fraction, the MRₛₒₗᵤ is the mass recovery obtained from GPC chromatogram and the a is the average mass constant for the sample calculated from Equation 1. The results for the yield of the extractable at 160° C. about the two depolymerized ground tire rubber samples shown in Table 7.

The method in Example 6 can be summarized in the following steps. Providing a depolymerized species of a depolymerization product as above. a) Dissolving the said GT depolymerization product sample with 1,2,4-trichlorobenzene solvent; b) filtering the solution to remove the insolubles and collecting the solution for the solubles; c) testing the solution about the solubles in GPC equipped with band-filter based detector such as IR4/IR5/IR6 (available from Polymer Char), calibrating GPC columns for molecular weight calculation with mono-dispersed polystyrene standards with MW range from 300 to 10 M, e) calibrating the IR detectors for mass quantification with Polystyrene, PolyIsoprene and Polybutadiene respectively, f) calibrating the IR detector for comonomer or C₂ content with ethylene-propylene copolymer or mixture of any combination from PE, PP and EP in which the C₂ content is pre-determined from NMR or FTIR measurements, g) converting the GPC chromatogram measured in c) into molecular weight distribution based on the column calibration given in d); h) Determining the C₂ content as a function of molecular weight for the said sample based on the comonomer calibration given in f); i) Assigning the peaks or shoulders in the GPC chromatogram given in c) into different species such as the butadiene, styrene and isoprene monomers or dimers or copolymers from them based on the value of molecular weight and C₂% content predicted from corresponding species, j) Calculating the peak area and the area fraction by fitting the peaks in the GPC chromatogram with multiple lognormal function; k) Converting the peak area fraction into mass fraction based on the mass constant measured in e) where the mass constant for copolymer species are calculated from the monomers in them by Equation 1; l) calculating the yield of the solvent extractables (the soluble portion in the whole sample) by Equation 2, m) and calculating the yield of each species by multiplying the total yield obtained in l) with the mass fraction obtained in k). 2. The total mass of the sample should be measured with the filter and the vial and the sample mass is obtained by subtracting the mass of the filter and the vial. The dissolution should be at temperature around 160° C. for 2 hours or longer to completely extract all the solubles. After the extraction, the filter with the insoluble is discarded while only the solution for the solubles is collected and sent to GPC test should be lifted above the liquid level of solvent. Proper amount of blank hot TCB solvent should be used to rinse the filter for a few minutes and the solution should also be collected in the same vial. The solution mass is measured by the total mass of solution plus vial subtracted by the mass of the empty vial which was measured previously. The volume of the liquid (Vol) is calculated by the total solution mass divided by the density of TCB at room temperature. Further, during the sample test, proper volume amount of solvent (about 8-Vol) is input as the volume for dissolution. The same number is also used as the input for polymer mass. This is to ensure that there is enough volume of liquid for GPC injection. The standard volume of liquid in vial for injection is 8 ml.

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

All numerical values within the detailed description are modified by “about” the indicated value, and take into account experimental error and variations that would be expected by a person having ordinary skill in the art.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

US claims:

1. A method comprising:
introducing a polymeric material, an unsaturated compound, and an olefin cross metathesis catalyst into a reactor, wherein the polymeric material comprises a carbon black filler;
reacting at least a portion of the polymeric material with the unsaturated compound in the presence of the olefin cross metathesis catalyst to produce at least metathesis oil and metathesis carbon black, wherein the metathesis oil comprises an olefin cross metathesis product of the polymeric material and the unsaturated compound; and
separating at least a portion of the metathesis carbon black.

2. The method of claim 1 wherein the polymeric material comprises one or more materials selected from the group consisting of butadiene rubbers, butyl rubbers, isoprene rubber, nitrile rubber, polychloroprene, styrene butadiene rubber, polyalkenamers, copolymers of alkenes with conjugated dienes, and combinations thereof.

3. The method of claim 1 wherein the polymeric material comprises one or more materials selected from the group consisting of rubber tires, rubber tire scraps, ground rubber tire material, tire rubber powder, and combinations thereof.

4. The method of claim 1 wherein the unsaturated compound comprises a material with a carbon number of C₂ to C₈₀ and at least one degree of unsaturation.

5. The method of claim 1 wherein the unsaturated compound comprises at least one material selected from the group consisting of polyethylene wax and polypropylene wax, steam cracker tar, vinyl ester, unsaturated polyoctene, vinyl cyclohexene, styrene, unsaturated poly alpha olefin, and combinations thereof.

6. The method of claim 1 wherein the unsaturated compound comprises at least one material selected from the group consisting of ethylene, propylene, 1-butene, 2-butene, butadiene, cyclopentene, cyclohexene, cyclohexadiene, and combinations thereof.

7. The method of claim 1 wherein the metathesis catalyst comprises at least one catalyst selected from the group consisting of organomolybdenum, organotungsten, organoruthenium, and combinations thereof.

8. The method of claim 1 wherein the metathesis catalyst comprises at least one catalyst selected from the group consisting of dichloro(3-phenyl-1H-inden-1-ylidene)bis(tricyclohexylphosphine)ruthenium(II), benzylidene-bis(tricyclohexylphosphine)dichlororuthenium, dichloro[1,3-bis(2,4,6-trimethylphenyl)-2-imidazolidinylidene](3-phenyl-1H-inden-1-ylidene)(tricyclohexylphosphine)ruthenium(II), benzylidene[1,3-bis(2,4,6-trimethylphenyl)-2-imidazolidinylidene]dichloro(tricyclohexylphosphine)ruthenium, (1,3-Bis-(2,4,6-trimethylphenyl)-2-imidazolidinylidene)dichloro(o-isopropoxyphenylmethylene)ruthenium, Dichloro[1,3-bis(2,6-isopropylphenyl)-2-imidazolidinylidene](2-isopropoxyphenylmethylene)ruthenium(II), dichloro[1,3-bis(2,4,6-trimethylphenyl)-2-imidazolidinylidene][(2-isopropoxy)(5-trifluoroacetamido)benzylidene]ruthenium(II), and combinations thereof.

9. The method of claim 1 wherein reacting at least the portion of the polymeric material with the unsaturated compound in the presence of the olefin cross metathesis catalyst comprises reacting at a temperature of about 10° C. to about 50° C.

10. The method of claim 1 wherein reacting at least the portion of the polymeric material with the unsaturated compound in the presence of the olefin cross metathesis catalyst comprises reacting at a pressure of about 1 bar to about 20 bar.

11. A method comprising:
introducing a polymeric material, an unsaturated compound, and an olefin cross metathesis catalyst into a screw extruder, wherein the polymeric material comprises a carbon black filler;
mixing the polymeric material and the unsaturated compound in a mixing zone in the screw extruder;
reacting at least a portion of the polymeric material with the unsaturated compound in the presence of the olefin cross metathesis catalyst to produce at least metathesis oil and metathesis carbon black, wherein the metathesis oil comprises an olefin cross metathesis product of the polymeric material and the unsaturated compound; and
separating at least a portion of the metathesis carbon black.

12. The method of claim 11 wherein the polymeric material comprises one or more materials selected from the group consisting of butadiene rubbers, butyl rubbers, isoprene rubber, nitrile rubber, poly chloroprene, styrene butadiene rubber, polyalkenamers, copolymers of alkenes with conjugated dienes, and combinations thereof.

13. The method of claim 11 wherein polymeric material comprises one or more materials selected from the group consisting of rubber tires, rubber tire scraps, ground rubber tire material, tire rubber powder, and combinations thereof.

14. The method of claim 11 wherein the unsaturated compound comprises a material with a carbon number of C₂ to C₈₀ and at least one degree of unsaturation.

15. The method of claim 11 wherein the metathesis catalyst comprises at least one catalyst selected from the group consisting of organomolybdenum, organotungsten, organoruthenium, and combinations thereof.

16. A method comprising:
introducing a polymeric material, a gaseous unsaturated compound, and an olefin cross metathesis catalyst into a reactor, wherein the polymeric material comprises a carbon black filler;
reacting at least a portion of the polymeric material with the gaseous unsaturated compound in the presence of the olefin cross metathesis catalyst at a temperature of about 10° C. to about 100° C. to produce at least metathesis oil and metathesis carbon black, wherein the metathesis oil comprises an olefin cross metathesis product of the polymeric material and the gaseous unsaturated compound; and
separating at least a portion of the metathesis carbon black.

17. The method of claim 16 wherein the polymeric material comprises one or more materials selected from the group consisting of butadiene rubbers, butyl rubbers, isoprene rubber, nitrile rubber, poly chloroprene, styrene butadiene rubber, polyalkenamers, copolymers of alkenes with conjugated dienes, and combinations thereof.

18. The method of claim 16 wherein polymeric material comprises one or more materials selected from the group consisting of rubber tires, rubber tire scraps, ground rubber tire material, tire rubber powder, and combinations thereof.

19. The method of claim 16 wherein the gaseous unsaturated compound comprises at least one material selected from the group consisting of ethylene, propylene, 1-butene, 2-butene, butadiene, and combinations thereof.

20. The method of claim 16 wherein the metathesis catalyst comprises a catalyst selected from the group consisting of organomolybdenum, organotungsten, organoruthenium, and combinations thereof.

21. A metathesis oil composition comprising the olefin cross metathesis product of the polymeric material and the unsaturated compound of claim 1.

22. A method for quantification of depolymerized species in metathesis oil composition produced from olefin cross metathesis of a polymeric material and an unsaturated compound comprising:
a) dissolving the metathesis oil with a solvent to form a first solution;
b) filtering the first solution and removing at least a portion of insoluble species in the metathesis oil thereby forming a second solution;
c) testing the second solution in a gel permeation chromatogram (GPC) equipped with band-filter based detector, wherein the GPC comprises peaks and shoulders;
d) calibrating a GPC column with mono-dispersed polystyrene standards with a molecular weight in a range from 300 to 10 M;
e) calibrating the band-filter based detector for mass quantification with polystyrene, polyisoprene, and polybutadiene;
f) calibrating the band-filter based detector for comonomer or C₂ content with ethylene-propylene copolymer or a mixture ethylene-propylene copolymer with polyethylene, polypropylene, and EP in which a C₂ content is pre-determined from nuclear magnetic resonance (NMR) or Fourier transform infrared measurements;
g) converting the GPC measured in c) into molecular weight distribution based on the GPC column calibration in d);
h) determining a C₂ content as a function of molecular weight for the metathesis oil composition based on a comonomer calibration in f);
i) assigning the peaks and shoulders in the GPC in c) to one or more species selected from the group consisting of butadiene, styrene monomer, isoprene monomer, dimers thereof, copolymers thereof, and combinations thereof based on a value of molecular weight and C₂% content for the species;
j) calculating a peak area and a peak area fraction by fitting the peaks and shoulders in the GPC with a multiple lognormal function;
k) converting the peak area fraction into mass fraction based on the calibration in e),
l) calculating a yield of solvent extractable portion of the metathesis oil; and
m) calculating a yield of each species in the metathesis oil.
